(19) United States
(12) Patent Application Publication
(10) Pub. No.: US 2009/0107276 A1
(43) Pub. Date: Apr. 30, 2009

(54) Device to Actuate an Automotive Gear Box and System to Transform an Actuation Device by Beams in an Actuation Device by Cables

(76) Inventor: Paolo Paparoni, Sao Bernado Do Campo (BR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 11/989,813

(22) PCT Filed: Jul. 27, 2005
(86) PCT No.: PCT/BR2005/000142

§ 371 Date: Aug. 12, 2008

(51) Int. Cl. F16H 61/36

(52) U.S. Cl. 74/473.15

(57) ABSTRACT

Device and system appropriate for an automotive gear box where, due to modifications in the arrangement of mechanical elements of a vehicle, the transmission system from the gear command to the gear box, originally conceived to be actuated by means of beams, should be transformed into a transmission system by double action flexible cables. The transformation is made substituting the actuation device by beams, as installed in the gear box, by a new actuation device by cables included outside said box, using the same assembly position and the same fixation elements to fix the beam device to be substituted, so that the new system does not require any change in the gear box.

The object of the present invention is a device to actuate an automotive gear box, and especially a system to transform an actuation device for a gear box, originally conceived to activated by means of beams, in a device actuated by double action cables.

As widely known, the movements of the gear shaft, activated by hand by the driver, are sent to the gear box where, by coupling and discoupling gears in the box, various transmission relations between the motors and the motor wheels are determined.

Conventionally, the transversal movements of the gear shaft, i.e. the crosswise movements to the sense of the gearing of the vehicle, command the selection of gears, while lengthwise movements of said shaft, i.e. in the sense of the gearing of the vehicle, command the gearing as previously selected.

Selection and gearing commands of gears as determined by the gear shaft may be sent to said gear box by means of beams, which are generally rigid bars able to transmit forces and linear and rotational movements, or may be sent by means of push-pull double action flexible cables, which allow to precisely send traction and compression forces and movements. Said cables are constituted by an external cover and an internal cable sliding within the cover.

Beams, being rigid, may use their rotation and translation to separately send selection and gearing commands. In case double action flexible cables are used, two cables are required, one for the selection command and another one for gearing command.

The transmission of gearing command by beams which is simple and has been widely used in the past is harder to be applied when the gear box is located in a point of the vehicle which is far from the command shaft, such as in vehicles with front traction or generally in all cases where a substantially straight connection between the shaft and the gear box is not possible. In these cases, selection and gearing commands are sent from the command shaft to a device to actuate the gear box by means of two double action cables.

The device to actuate the gear box, which is located within the box itself and joined to it, receives through the beam or the cables the commands from the shaft and transforms them in linear and rotating movements of a gear actuation tree, located within the gear box. Said actuation tree, by means of an arm fixed at its end, positions and couples gears to establish power transmission relations which were chosen by the driver by means of the command shaft.

In the development of successive models of a given type of car, layout changes in the mechanical part of the vehicle are sometimes required. As a consequence of eventual displacements of the mechanical components, it may be no longer possible to make straight communication between the gear shaft and the gear box, which previously allowed to use a rigid beam directly connecting said shaft to the actuation device of the gear box, unless inserting articulation points in the path that will allow the pending of the movements between the shaft and said box.

Obviously, this latter solution to insert intermediary articulations along the path requires a higher number of components and larger space, that is not always available, especially in smaller cars. Besides these inconveniences and due to the loss of precision in the set, the paths of the selection and gearing movements result longer than technically required, providing a feeling of less comfort for the vehicle user.

In the events as mentioned above, the most appropriate solution to transmit gear commands is to substitute the transmission system by a beam by the transmission system by flexible cables.

However, the substitution of the beam system by cable system requires changes in the device to actuate gear, and frequently in the gear box itself, even if the gear box of the new model is the same of the previous model. The required adaptations in the box would involve, in this case, additional work and costs for the assembler.

The object of this invention is to present a device to actuate a gear box allowing to substitute the transmission system by beam by the transmission system by cable as presented herewithin, with no need of any changes in the gear box itself.

This object is reached by means of a new actuation device by cables, that makes the conversion of the movements as sent by said cables to the linear and rotating movements of the actuation tree, externally to the gear box, so to be applied in place of the old beam device with no changes in the gear box itself. Within the box, the operational part of the actuation tree and the arm is the same and is located in the same position of the tree of the previous system, by selection and gearing as in the previous model. The gear box, including the connection flank with the new device, remains the same.

Therefore, the substitution of the old transmission system by beam by the new transmission system by cables is made by the simple change of one with the other, even using the same fixing holes on the opening flank of the box, with no change in the gear box, thus substantially reducing the work and cost of the new model.

Features, purpose and advantages of the system as presented in this invention become clearer with the detailed description of the attached drawings, wherein:

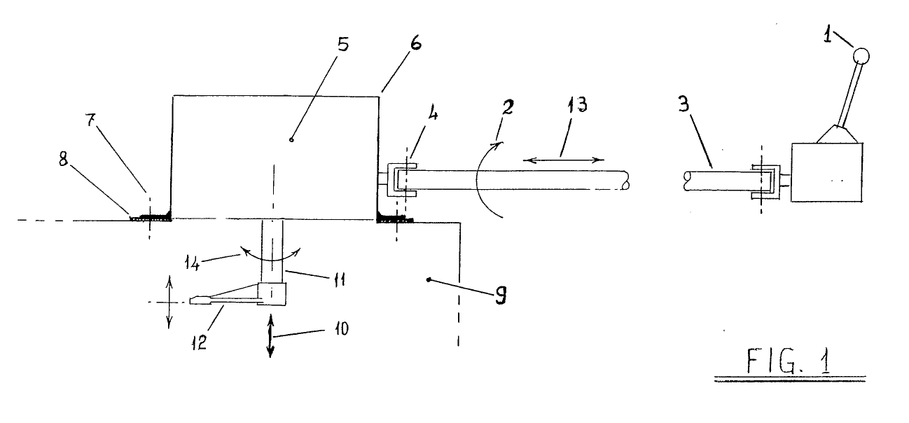

FIG. 1 is a schematic view of the usual gear command system by means of beam, showing the general operation scheme of this system;

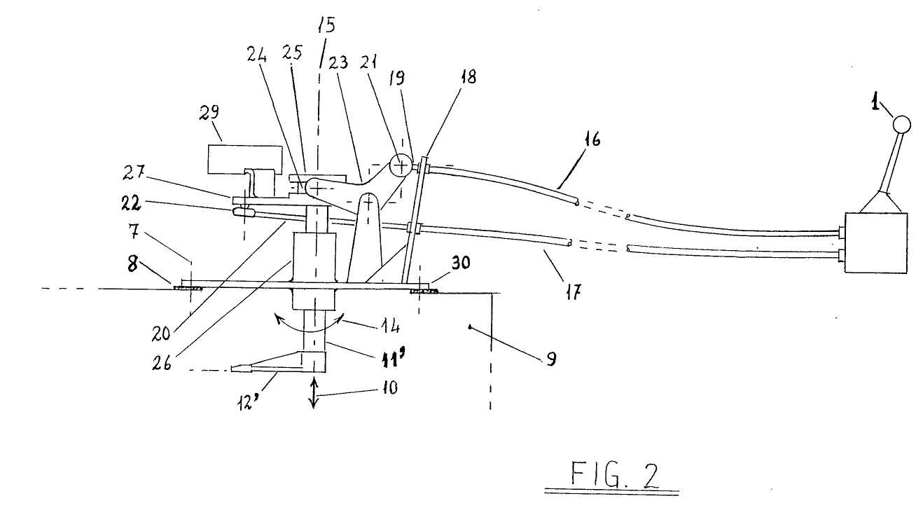

FIG. 2 is a side elevation view of the proposed gear command system, this time using cable transmission and a device to actuate the gear box which is the object of this invention; and

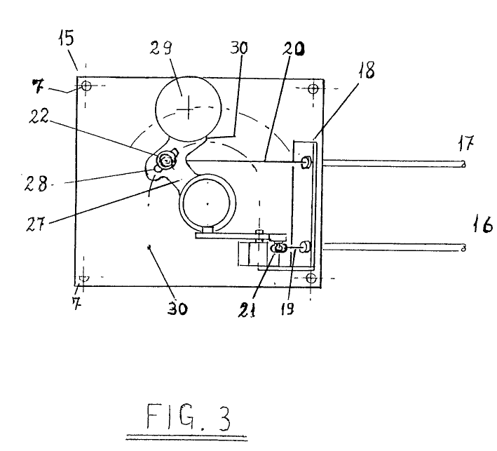

FIG. 3 is a view from above of the same actuation device of the gear box of FIG. 2, completing the illustration of operation of its components. With more specific reference to the drawings, FIG. 1 shows how the commands sent by the driver by means of the command gear (1) actuates the gear box when a transmission by beam is used. A crosswise movement of said command shaft (1) which, as already previously seen, constitutes a selection command, is transformed into a rotational movement (2) of the beam (3), which, by means of its articulated terminal (4), transfers it to the actuation device (5), not shown in the drawing, which is contained inside the cover (6) fixed by means of fixing (7) to the flank (8) of the gear box (9), only indicated in the drawing.

Upon receiving through the beam (3) said gear selection command, the actuation device (5) produces an axial movement (10) in the actuation tree (11) and the arm (12) as fixed at its end. Said arm, while vertically displaced, selects a couple of gears, one of which may be geared depending on the gearing movement to be received from the command shaft.

When the gearing command is given by the driver by actuating the command shaft (1) lengthwise, i.e. in the sense of the gearing of the vehicle, which in the drawing is the sense from the shaft (1) to the box (9), said gear command results in an axial movement (13) of the beam (3) that, by means of the articulated terminal (4) and the action of the actuation device (5), causes a rotation movement (14) in the actuation tree (11) causing the rotation of the arm (12) in one or in the other sense. Depending on the sense, such rotational movement couples gears so to effect gearing in one of the two gears as previously selected by the selection movement.

The new actuation device as presented herewithin to transform the transmission system by beam into a transmission system by cables is shown by FIGS. 2 and 3.

We can see in these figures that the command shaft (1) transfers this time its commands to the new actuation device (15) by means of the two double action cables, which are the cable (16) to command the selection and the cable (17) to command gearing.

The end fittings of the external covers of both cables (16) and (17) are fixed to a terminal plate (18) of the new actuation device (15), with both cores (19) and (20) of the cables (16) and (17) follow up to the corresponding terminals (21) of section and (22) of gearing.

The terminal (21) of the cores (19) of the cable (16) of the selection is articulated at an end of an angle arm (23) with a horizontal axis, that transforms the lengthwise movement of the cable into a vertical movement of the new actuation tree (11′) and its arm (12′), actuating the gearing selection just like the previous device was actuated with a beam. A semicircular channel (24) within the head (25) of the actuation tree (11′) allows the angle arm (23) to vertically actuate said tree, whatever may be its rotational position. The guide bush (26) of the actuation tree (11′) includes a spring, unseen in the drawing, that always return said tree (11′) to the neutral position of the vertical movement of the selection.

Once the desired vertical position of the selection is reached, the driver actuates the shaft (1) lengthwise to gear as previously selected. This gearing command is sent by the cable (17) and follows through the core (20) of this cable up to the terminal (22) that is articulated to the gearing arm (27) to effect angle rotation (14) of the actuation tree (11′) and the arm (12′).

Inertial mass (29), when required, is fixed to an end (30) of the gearing arm (27) to make the gearing movement become smoother.

In counterposition with the previous device (5), that was contained within the cover (6) and therefore within the gear box (9), the set of the new actuation device (15) is built over the cover (30) and therefore out of the gear box (9), as clearly shown by FIGS. 2 and 3.

Both the previous cover (6) and the new cover (30) have the same fixation means (7) and the same location of said fixation means (7) in the gear box (9), making it possible to fix the new device (15) over the same flank (8) of the opening of said box (9), so that the change from the old to the new actuation device may be made with no changes in the gear box (9). The system to transform the actuation device (5) by beams into the new actuation device (15) by cables is consequently extremely easy, since it only requires to substitute a set with the other one, even with the same covers, and connect the cables (16) and (17) as previously disclosed and shown in the drawings.

It is understood that the presented solution may be modified and varied in its way of embodiment, as long as not escaping from the purpose of the invention, as expressed in the attached claims.

1. Device to actuate an automotive gear box system to transform an actuation device by beams into an actuation device by cables, wherein the actuation device is the type of device included next to the gear box to select and gear within said box, therefore making the change of gears according to the selection and gearing commands as sent by the driver through the command shaft, wherein, in occasions where the substitution of a transmission system, originally conceived to be actuated by a beam, becomes required, not changing the gear box itself, the substitution of the device is made by means of a new actuation device which receives the shaft commands through the selection and gearing cables, being the selection movements of the cable transformed by an angle shaft into an axial movement of the actuation tree, which will activate gearing selection by means of its arm and the gearing movements of the cable are transformed by a shaft into rotational movement of the actuation tree that will effect gearing as selected by the rotation of the same arm and wherein the set of the actuation device, operated by cables is built over the cover of the gear box.

2. Device to actuate an automotive gear box and system to transform an actuation device by beams into an actuation device by cables of claim 1, wherein the actuation device is located on the external face of the cover of the gear box.

3. Device to actuate an automotive gear box and system to transform an actuation device by beams into an actuation device by cables of claim 1, wherein the positioning and operation of the part of the actuation tree that is inside the gear box, next to the arm, to effect selection and gearing, is the same positioning and the same operation of the actuation tree and the arm of the previous device, actuated by a beam.

4. Device to actuate an automotive gear box and system to transform an actuation device by beams into an actuation device by cables of claim 1, wherein the transformation of a device with its beam into a device with its cables is made by taking out the set of the first one, fixing in its place the set of the second one with the same fixation means and allowing the subsequent make the adjustment of cables to optimize the movement.
